(19) United States
(12) Patent Application Publication
(10) Pub. No.: US 2014/0149586 A1
(43) Pub. Date: May 29, 2014

(54) INTERNET PANEL FOR CAPTURING ACTIVE AND INTENTIONAL ONLINE ACTIVITY

(71) Applicant: VINDICO LLC, Irvine, CA (US)

(72) Inventors: Christophe L. Clapp, Corona, CA (US); Brian C. DeFrancesco, Trabuco Canyon, CA (US)

(73) Assignee: VINDICO LLC, Irvine, CA (US)

(21) Appl. No.: 14/084,444

(22) Filed: Nov. 19, 2013

Related U.S. Application Data
(60) Provisional application No. 61/731,253, filed on Nov. 29, 2012.

(51) Int. Cl. H04L 29/08

(52) U.S. Cl. CPC H04L 67/22
USPC 709/224

(57) ABSTRACT

A method, apparatus, system, and computer program product provide the ability to capture online activity. A group of Internet users that is representative of a portion of all Internet users is determined. A browser extension is installed onto an Internet browser of each of the Internet users in the group. Data for active and intentional webpage visits is identified, captured, and collected, via the browser extension, from each of the Internet users. The data is then utilized.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/731,253, filed on Nov. 29, 2012, by Christophe L. Clapp and Brian C. DeFrancesco, entitled “Internet Panel for Capturing Active and Intentional Online Activity,” attorneys' docket number 257.71-US-P1.

### BACKGROUND OF THE INVENTION

1. Field of the Invention

The present invention relates generally to tracking a user's Internet activity, and in particular, to a method, apparatus, and article of manufacture for an Internet panel that captures active and intentional online activity including website visitation, online advertisements, and content exposure.

2. Description of the Related Art

In an online context, advertising is often a crucial component and may provide one of the only mechanisms for a website to enable a sufficient return on investment. Accordingly, it is desirable to maximize the revenue received from advertisements. In this regard, the more accurately an advertisement can target a particular user (or group of users), the higher the amount that can be charged for an advertisement delivered to such a user. Further, advertisers have a vested interest in maximizing the number of users that have an opportunity to see an advertisement as well as maximizing the demographic that an advertisement is delivered to. The ability to determine active, intentional, real user based website visits along with subsequent content and advertisement exposure is not available in the prior art. Further, the prior art fails to provide a mechanism for comprehensively comparing/rating/ranking websites with regard to the website's advertisement placement value. In addition, the prior art fails to provide such capabilities that are performed in an anonymous manner.

In view of the above, what is needed is the ability to anonymously monitor and collect Internet based activity including visitations to websites, and exposure to online advertisements and media/content. Further, what is needed is the ability to rate and rank websites, online advertisements, and online media/content based on active and intentional real user exposure.

### SUMMARY OF THE INVENTION

Embodiments of the invention provide a method, apparatus, system, article of manufacture, and computer program product for an Internet based “panel” (or group of persons) comprised of active Internet users who allow for the anonymous monitoring and collection of Internet based activity including website visitation, online advertisement and media/content exposure. The system and data collection methodology allow for the rating and ranking of websites, online advertisements, and online media/content based on active and intentional real user exposure.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates a browser extension and data capture architecture used in accordance with one or more embodiments of the invention;

FIGS. 4A and 4B illustrate examples of browser address bars in Mozilla Firefox™ and Google Chrome™ respectively;

FIG. 5 illustrates the browser extension API class model for Google Chrome™ that may be used in accordance with one or more embodiments of the invention;

FIG. 6 illustrates a browser object model that may be used in accordance with one or more embodiments of the invention; and

FIG. 7 is a flowchart illustrating the logical flow for utilizing an internet panel to capture online activity in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

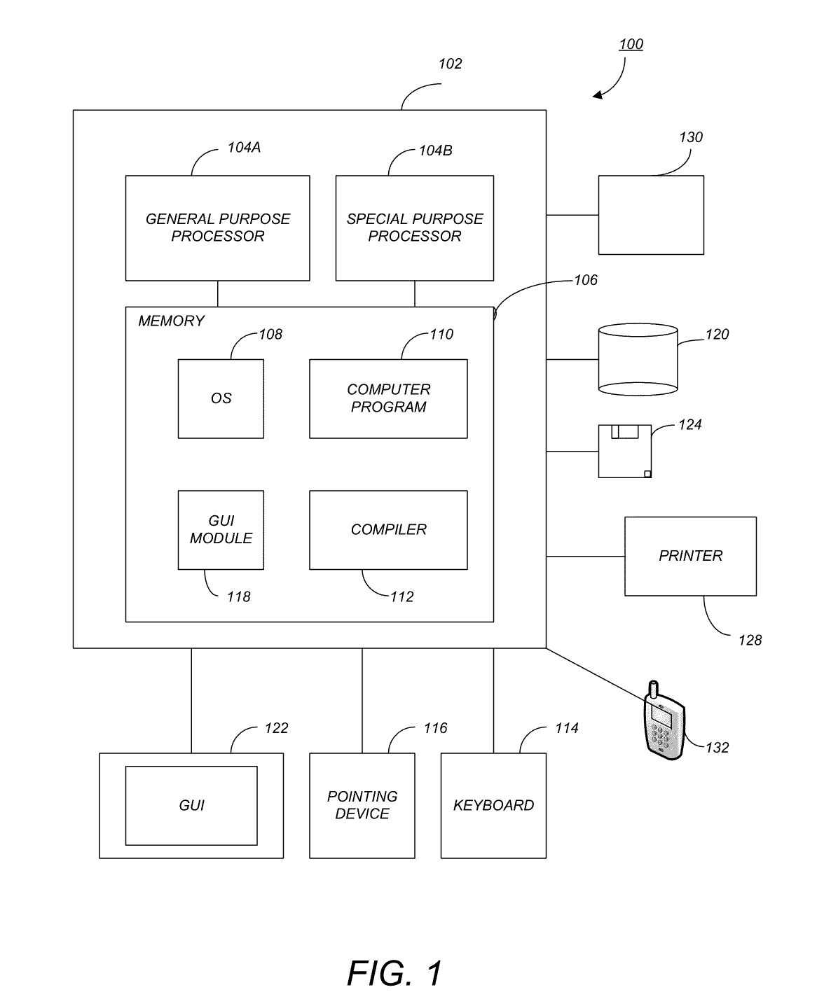

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

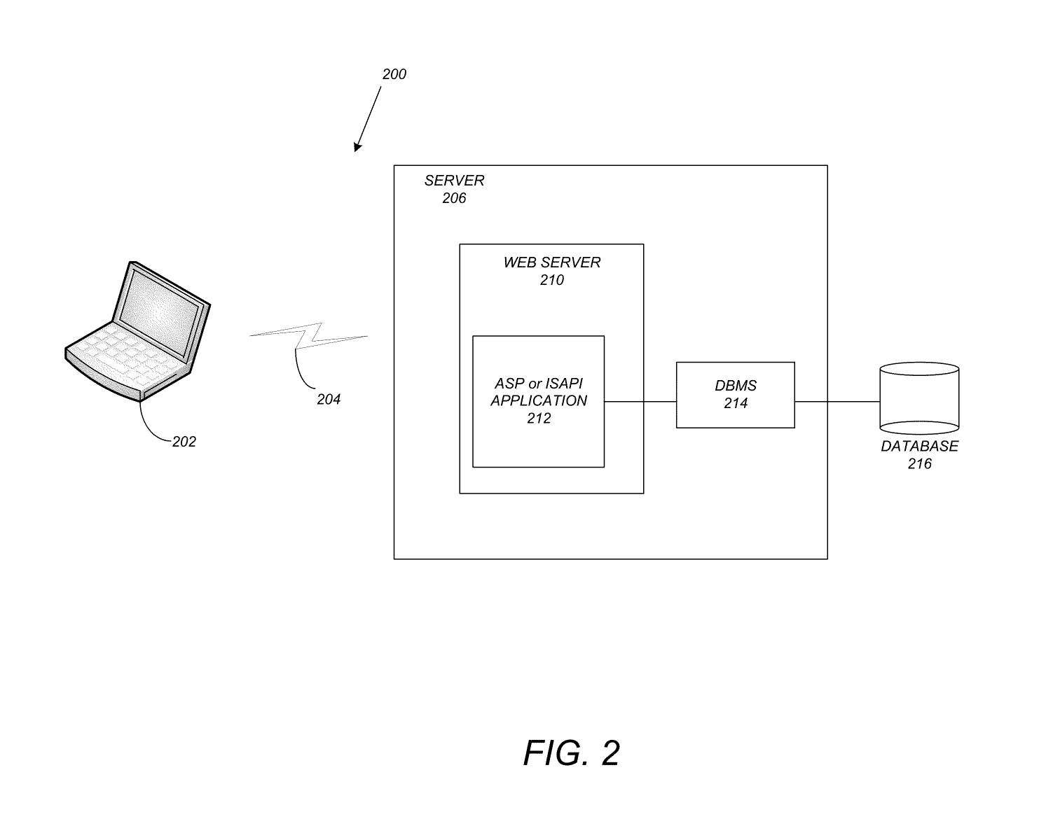

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### DEFINITIONS

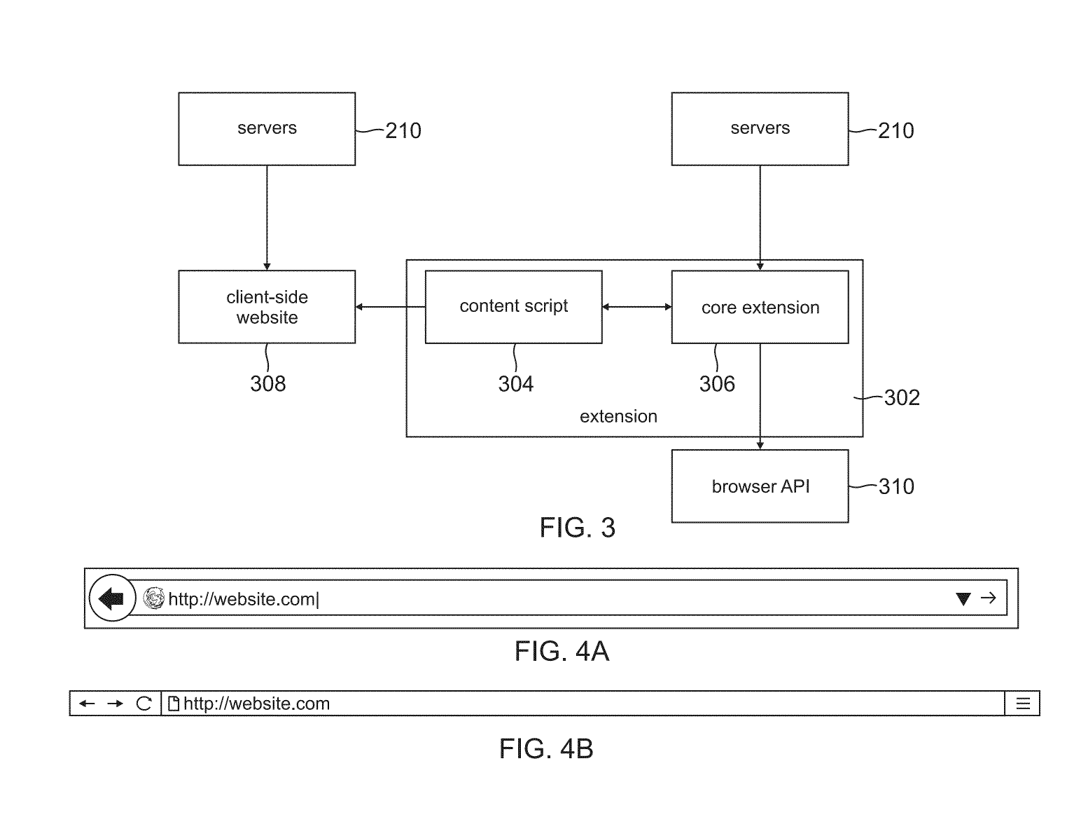

FIG. 3 illustrates a browser extension and data capture architecture used in accordance with one or more embodiments of the invention. The definitions for various terms are set forth below and refer to the architecture of FIG. 3.

Online Panel

A group of Internet users who represent a larger portion of all Internet users and allow for their online activity to be tracked and aggregated to create statistically significant projections for the entire population of users.

Panelist

An active and real (non-automated) Internet user who has enabled and allowed anonymous monitoring and capturing of their online activity.

Browser

Short for web browser, a software application used to locate, retrieve and also display content via the World Wide Web, including webpages, images, video and other files. In a client/server model, the browser is the client run on a computer that contacts the Web server 210 and requests information. The web server 210 sends the information back to the web browser, which displays the results on the computer or other Internet-enabled device that supports a browser.

Browser Extension

Extensions 302 are small software programs that can modify and enhance the functionality of the browser. These range from customized news readers to online games. Extensions 302 can also provide the ability to tailor the browser's look and feel in several different formats. They can be written using web technologies such as HTML (hypertext markup language), JAVASCRIPT™, and CSS (cascading style sheets). Extensions 302 are available to download safely from browser hosted web pages such as Mozilla's Firefox Add-Ons page (https://addons.mozilla.org/en-US/firefox/) and Google's Chrome Webstore (https://chrome.google.com/webstore/).

Extensions 302 are built so that they are robust to attacks originating from malicious websites and the network. Accordingly, extensions 302 can read and manipulate content from websites 308, make unfettered network requests, and access browser user data like bookmarks and geolocation. To prevent and mitigate the abuse of such privileges, extensions 302 may be built from two types of components that are isolated from each other (thereby adhering to a privilege-separated architecture): content scripts 304 and core extensions 306. Content scripts 304 interact with websites 308 and execute with no privileges. Core extensions 306 do not directly interact with websites and execute with the extension's full privileges. Content scripts 304 can read and modify website 308 content, but content scripts 304 and websites 308 have separate program heaps so that websites 308 cannot access scripts' functions or variables. Further, each extension 302 may come packaged with a list of permissions, which govern access to the browser APIs 310 and web domains. If an extension 302 has a core extension 306 vulnerability, the attacker may only gain access to the permissions that the vulnerable extension already has.

API

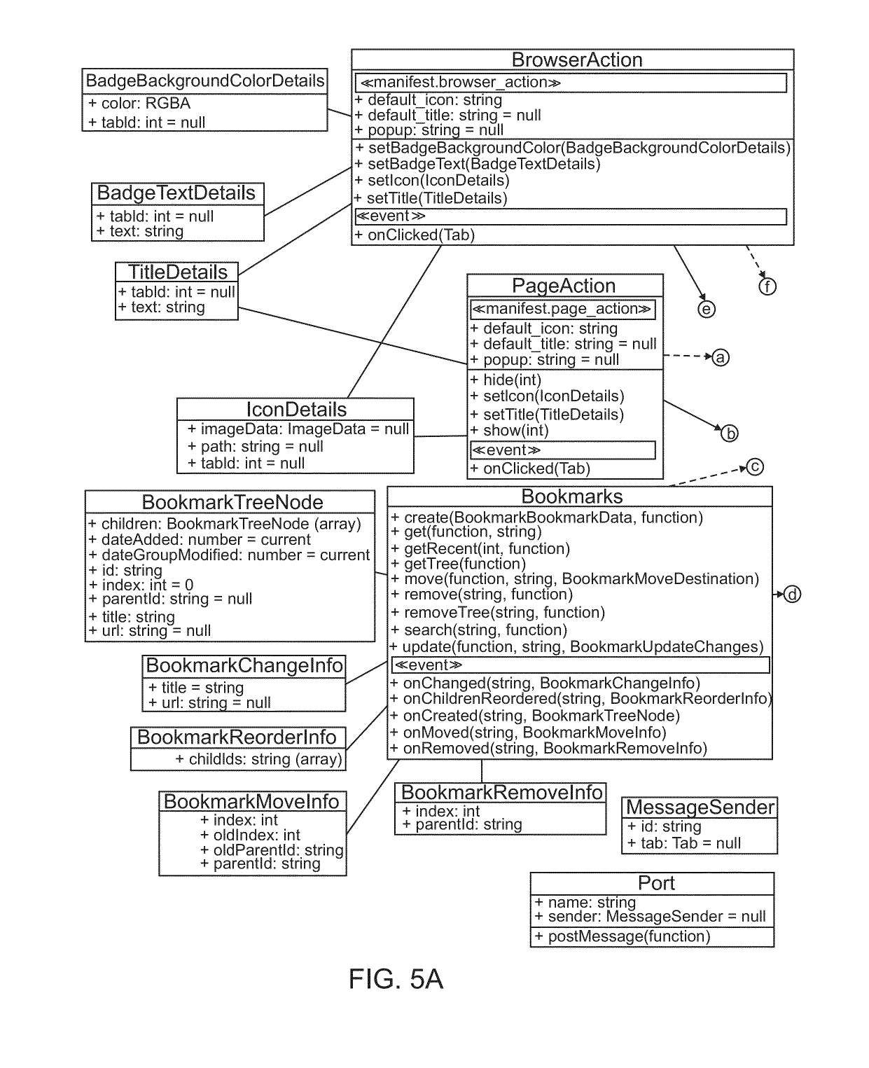

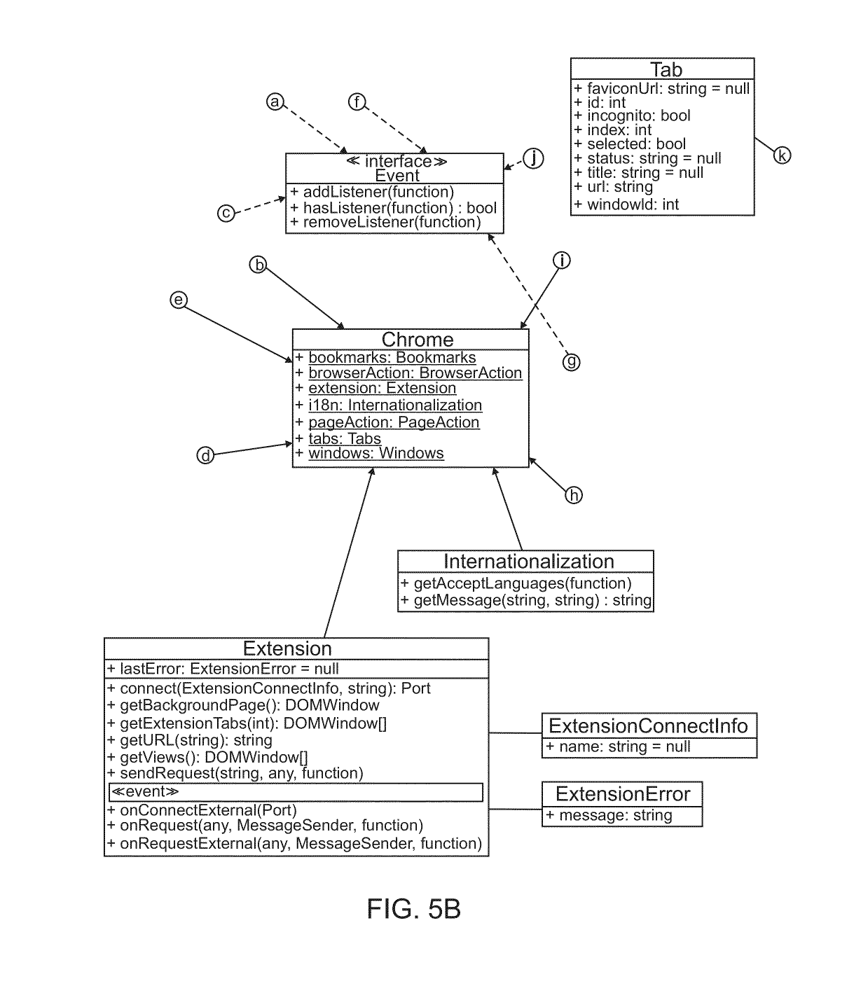

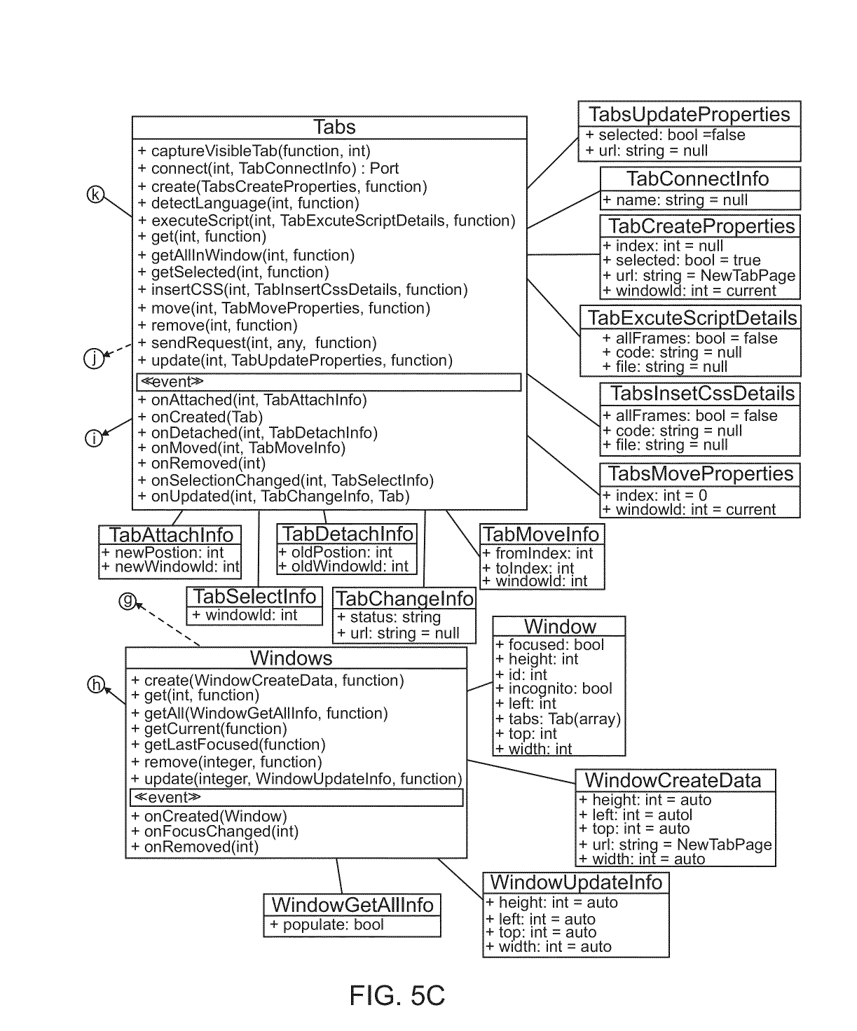

API stands for “Application Program Interface,” though it is sometimes referred to as an “Application Programming Interface.” An API is a set of commands, functions, and protocols that programmers can use when building software for a specific system. The API allows programmers to access and use predefined functions to interact with the system, instead of writing them from scratch. For browser extensions, browser API's 310 enable and allow extensions 302 to interact with the browser. A list of Mozilla Firefox's API's can be found at https://addons.mozilla.org/en-US/developers/docs/reference. Google Chrome's browser extension API's can be found at http://developer.chrome.com/extensions/api_index.html. FIG. 5 illustrates the browser extension API class model for Google Chrome™ that may be used in accordance with one or more embodiments of the invention.

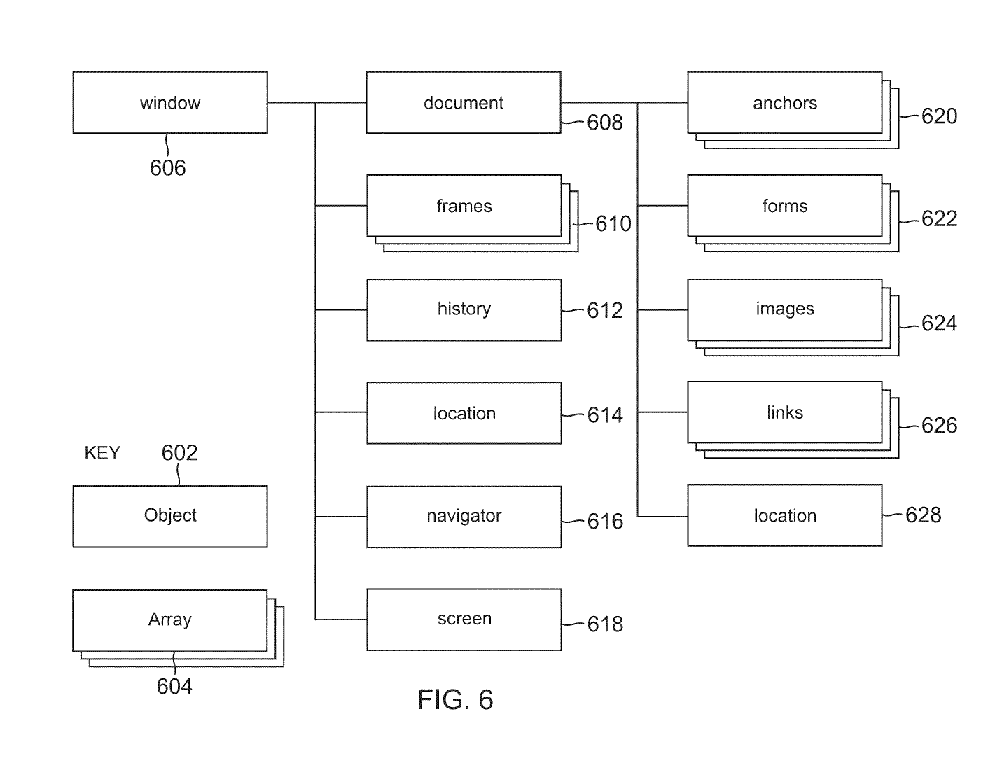

FIG. 6 illustrates a browser object model that may be used in accordance with one or more embodiments of the invention. In a browser object model, there are objects 602 and arrays 604. A browser window 606 may serve as the root object and can include document objects 608, frames 610, history objects 612, location objects 614, navigator objects 616, and screen objects 618. The document object 608 may include anchors 620, forms 622, images 624, links 626, and location objects 628. Together, the components 606-628 define the web page viewed in the browser window 606.

URL

Stands for “Uniform Resource Locator.” A URL is the address of a specific web site or file on the Internet. Some examples of URLs are http://www.cnet.com/, http://web.mit.edu/, and ftp://info.apple.com/.

Address Bar

An address bar is a text field near the top of a web browser window that displays the URL of the current webpage. The URL, or web address, reflects the address of the current page and automatically changes whenever a new webpage is visited. Therefore, one can always check the location of the webpage that is currently being viewed with the browser's address bar. While the URL in the address bar updates automatically when a new page is visited, a user can also manually enter a web address.

FIGS. 4A and 4B illustrate examples of browser address bars in Mozilla Firefox™ and Google Chrome™ respectively.

Website

A website (or client-side website 308) is a set of interconnected webpages, usually including a homepage, generally located on the same server 206, and prepared and maintained as a collection of information by a person, group, or organization.

Webpage

A document on the World Wide Web, consisting of an HTML file and any related files for scripts and graphics, and often hyperlinked to other documents on the Web. The content of webpages is normally accessed by using a browser.

Hypertext Transfer Protocol (HTTP)

The Hypertext Transfer Protocol provides a standard for Web browsers and servers to communicate. HTTP is an application layer network protocol built on top of TCP (transmission control protocol). HTTP clients (such as web browsers) and servers communicate via HTTP request and response messages.

### Software Embodiments

Embodiments of the invention are implemented as a software application on a client 202 or server computer 206. Further, as described above, the client 202 or server computer 206 may comprise a thin client device or a portable device that has a multi-touch-based display.

Embodiments of the invention relate to identifying, collecting, and aggregating panelist's active and intentional webpage visits and the subsequent ads and media/content delivered on these webpages to create systems for rating and ranking websites, ads, and media based on valid, visible, and intentional exposure.

For a webpage visit to be considered active and intentional, the webpage loading must be initiated by a real user and viewed for a period of time of at least seven (7) seconds.

Active and Intentional Website Visitation Criteria

Embodiments of the Invention Enable Tracking Only Active and Intentional website visits from real users so that rating and ranking websites is not skewed by fraudulent, biased, or otherwise inaccurate data. The criteria for “Active”, “Intentional”, and “Real User” classification can be found below:

Active

The browser window/tab displaying the webpage must be opened by the user and have focus over all other windows/tabs for a period of at least seven (7) seconds.

Intentional

The webpage of a website must be loaded in a browser window/tab. This means the webpage URL must be visible in the browser window/tab's address bar. Therefore, this excludes webpages that are embedded into other webpages, webpages that are perfected or prerendered only, webpages requested outside of a browser environment (scripting or server requests), or webpages requested from within the browser but that are not displayed in a window/tab a result of methods such as XMLHttpRequest.

Prefecting (Prerendering): The browser fetches all of the sub-resources and does all of the work necessary to display the page in the event the user completes the request to see the page. This is done so that, in many cases, the site simply seems to load instantly when the user clicks to load it.

XMLHttpRequest: The XMLHttpRequest object is used for a browser to exchange data with a server in the background. It provides an easy way to retrieve data at a URL. XMLHttpRequest can be used to retrieve any type of data, and it supports protocols other than HTTP (including file and ftp). All modern browsers (IE7+, Firefox, Chrome, Safari, and Opera) have a built-in XMLHttpRequest object.

Furthermore, the webpage loaded in a browser window/tab and displayed in the address bar, must not be the result of a forced, deceitful, or malicious action. This includes webpages loaded from non-user initiated pop-up/pop-under windows, cross-domain website redirects, clickjacking, or any other non-user initiated means.

Non-User Initiated Pop-Up/Pop-Under Windows: A window that opens without the user initiating it. These are typically produced with JavaScript™ code that is inserted into the HTML of a webpage. Some pop-up windows show up in front of the main window, while others show up behind the main browser window. Pop-Up windows that appear behind open windows are also called “pop-under” windows.

Non-User Initiated Cross-Domain Website Redirects: Automatic (server side or client side), non-user initiated, redirecting of the webpage from a webpage on one domain (example: abc.com) to a webpage on another domain (example: xyz.com).

Click Jacking: Clickjacking (User Interface redress attack, UI redress attack, UI redressing) is a malicious technique of tricking a Web user into clicking on something different to what the user perceives they are clicking on, thus potentially revealing confidential information or taking control of their web browser while clicking on seemingly innocuous web pages. It is a browser security issue that is a vulnerability across a variety of browsers and platforms, a clickjack takes the form of embedded code or a script that can execute without the user's knowledge, such as clicking on a button that appears to perform another function.

Real User

To ensure all panelists are real users and not bots or automated systems, each panelist's activity is monitored and aggregated to verify that it does not exceed thresholds for activity from real users. This includes monitoring and aggregating the volume of website and webpages loaded by the panelist in a defined period of time and is re-configurable as deemed necessary by the latest internet activity trends.

To provide a system to identify and collect data based on the criteria defined above, the panelists grant direct access to their browser's APIs, HTTP web requests, tab and window activity through a browser extension. Through the browser extension code, this system is able to identify, capture, and collect active and intentional data from real users that includes, but is not limited to:

Website and Webpage Visitation: Webpage and website visitation is captured by monitoring browser API events indicating a webpage has loaded in a window/tab. For example, in Google Chrome™ this would be monitored using the Chrome browser API chrome.webNavigation.onCommitted

Browser Window Environment: Browser window data is captured by leveraging the browser extension to access each window object through browser APIs such as Google Chrome's content_scripts. Window characteristics including the window that opened it (window.opener), status bar (address bar) visibility, size, and menu bar visibility can be used to determine if window has characteristics of a pop-up/pop-under. Furthermore, this can be combined with data indicating how the window was opened (link, bookmark, or other use initiated action) obtained from browser APIs such as Google Chrome's chrome.webNavigation.onCommitted (specifically transitionType).

Browser Redirects: By using browser API events for when navigation to a webpage starts and when the completed event occurs, the system is able to know if a webpage is redirected. In Google Chrome, this would be accomplished using chrome.webNavigation.onBeforeNavigate and chrome.webNavigation.onCommitted Automated or script based redirection, such as redirects via client side Javascript™ by replacing the window/document location, is captured by the lack of a user event (such as a click) preceding the webpage loading in an existing browser window/tab.

Clickjacking: By leveraging browser extension APIs for accessing events to indicate how a webpage was opened, such as Google Chrome's chrome.webNavigation.onCommitted (specifically transitionType), and content_scripts to monitor the window's document elements and their css style properties, the system is able to monitor where clicks originate from and if they are the result of a non-intentional event.

Active Window/Tab: Whether a window/tab displaying a webpage becomes active (in focus amongst all browser's windows/tabs) and for how long is captured by using browser API events indicating the window/tab has focus and is active. For example, in Google Chrome this would be monitored using chrome.tabs.onActivated. The browser extension code can set a timer to start and stop when a tab is active to track the duration the webpage is potentially viewable to the user.

Online Advertisement and Media/Content Exposure: The browser extension is able to capture all HTTP request activity generated by the browser. This is done via browser extension APIs. For example, in Google Chrome, this would be monitored using chrome.webRequest.on Completed. By examining each HTTP webrequest, advertisements and media can be found using the following methodology:

(1) Check if hostname of HTTP webrequest is for a commonly used advertising or an advertising ad server domain such as Google's ad sever, doubleclick.net.

(2) Examine the HTTP webrequest and/or response to confirm it contains an advertisement or media file based on content type, size, and other identifying factors.

(3) Collect and group potential advertisements and media files and have a team of humans validate and identify the brand/advertiser promoted by each ad and verify the media file.

(4) Store human classifications of advertisements and media files so subsequent human review of similar files can be automated and aggregate activity for each confirmed advertisement or media file.

The advertisement and media/content data is coupled with data relating to the window/tab responsible for a webrequest including the webpage and frame that initiated the webrequest.

### Exemplary Use Cases

The applicable use of capturing active and intentional online activity from an internet panel includes, but is not limited to, rating and ranking websites, rating and ranking of online advertisement exposure, and measurement of distribution of online media.

By tracking and aggregating only active and intentional internet activity data from real users, a system of rating and ranking websites, online advertisement exposure, and online media distribution is created based on fair, accurate, and intentionally viewed online activity.

Rating and Ranking Websites

Websites may be rated and ranked by aggregating “visits” to webpages of a website where a visit is simply the loading of the webpage with limited context regarding how it was loaded, where it was loaded, or if it was actively viewed by a real user. Therefore, common website traffic ranking can be easily biased, skewed, or otherwise inaccurate as the result of commonly used traffic generation methods including, but not limited to embedding a webpage on another webpage, server side requests or client side requests that do not display the webpage in a browser, prefetching or prerendering, pop-up/pop-under windows, redirects, etc. By aggregating only intentional and actively viewed webpage visits, the system is able to accurately and effectively rate and rank websites in terms of user/audience reach and page views.

For example, if a content owner is looking for distribution of their content online, they would have the ability to choose which websites to pay for distribution based on which websites provide the most value in terms of user reach and page views from real users who intentionally visit and actively view the website.

Rating and Ranking of Online Advertisement Exposure

Online advertisements are typically delivered dynamically and the decision for which advertisement to show to a user is determined when the webpage is loaded by the user. For example, Real-Time Bidding (RTB) is a commonly used method in online advertising where, at the time an ad is to be shown on a webpage, an online auction allows bidders to bid on which advertisement to show to the user.

RTB and the embedding of HTML windows documents within other window documents have created issues in transparency regarding always knowing where and how an advertisement is delivered. With this system, a major brand advertiser could see their ads total distribution including total panel reach, statistically significant estimated population reach (based on panel measurement), and the relative rate and rank of webpages and websites it's appearing on including the rate of intentional and active real user viewership, and the duration of the time that the page was active. This data can also be used by the advertiser to rate and understand value and rank platforms, websites, and distribution partners.

Measurement of Distribution of Online Media

Online media/content can be distributed through different websites as a part of syndication, partnerships, or by websites' acting on their own to display the content/media. This can occur with or without the content owner/producer's consent. Furthermore, media files can be extracted, duplicated, and republished with or without the owner's consent. This system allows for the de-duplication of media/content files and the aggregation of the panel's exposure to the media/content to measure the overall distribution, user reach, and rate/rank of webpages where the content/media displayed.

For example, if a brand produces a short video that promotes their products for online distribution and asks a number of websites to post the video, the websites may download and then upload the video on their own hosting server or they may embed the video directly from the producer's server. Furthermore, the video may be placed on other websites that, acting on their own accord, make the content available to their users by embedding or otherwise hosting the content. This system allows the owner/producer of the content to see its total distribution including total panel reach, statistically significant estimated population reach (based on panel measurement), and the relative rate and rank of webpages and websites it's appearing on including the rate of intentional and active real user viewership.

### Logical Flow

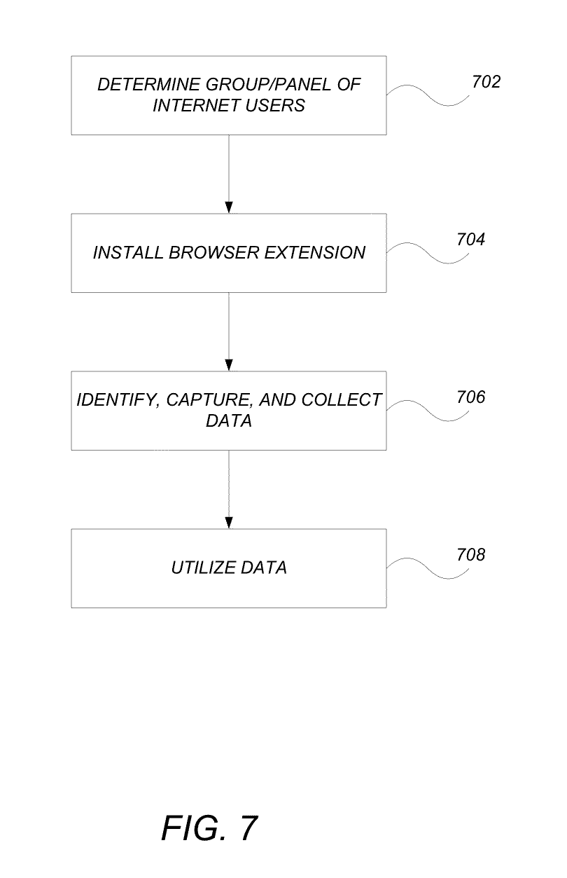

FIG. 7 is a flowchart illustrating the logical flow for utilizing an Internet panel to capture online activity in accordance with one or more embodiments of the invention.

At step 702, a group of Internet users that is representative of a portion of all Internet users is determined.

At step 704, a browser extension is installed onto an Internet browser of each of the Internet users in the group.

At step 706, via the browser extension, data for active and intentional webpage visits from each of the Internet users is identified, captured, and collected. The identifying, capturing, and collecting may further include the monitoring and aggregating of the data for each of the Internet users. The aggregated data may then be compared to a threshold for activity from real users. Based on the comparison, the system may ensure that each of the Internet users is a real user. A webpage visit may be considered active and intentional when a URL for the webpage is visible in a browser window/tab's address bar and/or when a loading of the webpage is initiated by a real user and viewed for a period of time at least seven (7) seconds.

The data may include website and webpage visitation that is captured by monitoring browser API events indicating a webpage has loaded in a window/tab of the Internet browser. The data may also comprise browser window environment data that is captured by leveraging the browser extension to access each window object through a browser API. In addition, the data may include browser redirects that are detected using browser API events that detect when navigation to a webpage starts and when a completed even occurs. Furthermore, the data may be clickjacking information that is detected by leveraging browser extension API events that indicate how a webpage was opened. Also, the data may be information regarding whether and how long a window/tab displaying a webpage becomes active or online advertisement and media/content exposure (e.g., that is detected by browser extensions that capture all HTTP request activity generated by the browser).

At step 708, the data is utilized. In this regard, based on the data, websites may be rated and/or ranked in terms of user/audience reach and page views. Alternatively, online advertisement exposure may be rated and ranked. In addition, the data may be used to determine the distribution of online media content.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for capturing online activity comprising:
determining a group of Internet users that is representative of a portion of all Internet users;
installing a browser extension onto an Internet browser of each of the Internet users in the group;
identifying, capturing, and collecting, via the browser extension, data for active and intentional webpage visits from each of the Internet users; and
utilizing the data.

2. The method of claim 1, further comprising:
monitoring and aggregating the data for each of the Internet users;
comparing the aggregated data to a threshold for activity from real users; and
ensuring that each of the Internet users is a real user based on the comparing.

3. The method of claim 1, wherein:
the data comprises website and webpage visitation that is captured by monitoring browser application programming interface events indicating a webpage has loaded in a window/tab of the Internet browser.

4. The method of claim 1, wherein:
the data comprises browser window environment data that is captured by leveraging the browser extension to access each window object through a browser application programming interface.

5. The method of claim 1, wherein:
the data comprises a browser redirect that is detected using a browser application programming interface event that detects when navigation to a webpage starts and when a completed event occurs.

6. The method of claim 1, wherein:
the data comprises clickjacking information that is detected by leveraging a browser extension application programming interface event that indicates how a webpage was opened.

7. The method of claim 1, wherein:
the data comprises information regarding whether and how long a window/tab displaying a webpage becomes active.

8. The method of claim 1, wherein:
the data comprises online advertisement and media/content exposure, that is detected by the browser extension that captures all hypertext transfer protocol (HTTP) request activity generated by the Internet browser.

9. The method of claim 1, wherein:
a webpage visit is intentional when a uniform resource locator (URL) for the webpage is visible in a browser window/tab's address bar.

10. The method of claim 1, wherein:
a webpage visit is active and intentional when a loading of the webpage is initiated by a real user and viewed for a period of time of at least seven (7) seconds.

11. The method of claim 1, wherein utilizing the data comprises:
based on the data, rating and ranking websites in terms of user/audience reach and page views.

12. The method of claim 1, wherein utilizing the data comprises:
based on the data, rating and ranking online advertisement exposure.

13. The method of claim 1, wherein utilizing the data comprises:
based on the data, measuring a distribution of online media content.

14. A system for capturing online activity comprising:
(a) a server computer configured to:
(1) determine a group of Internet users that is representative of a portion of all Internet users;
(2) transmit one or more browser extensions that are installed onto an Internet browser of each of the Internet users in the group;
(3) receive Internet browsing data from the one or more browser extensions; and
(4) determine if the Internet browsing data is based on active and intentional webpage visits; and
(5) utilizing the Internet browsing data; and
(b) the browser extension configured to:
(1) identify, capture, and collect, the Internet browsing data; and
(2) transmit the Internet browsing data to the server.

15. The system of claim 14, wherein the server is further configured to:
monitor and aggregate the Internet browsing data for each of the Internet users;
compare the aggregated Internet browsing data to a threshold for activity from real users; and
ensure that each of the Internet users is a real user based on the comparison.

16. The system of claim 14, wherein:
the Internet browsing data comprises website and webpage visitation that is captured by monitoring browser application programming interface events indicating a webpage has loaded in a window/tab of the Internet browser.

17. The system of claim 14, wherein:
the Internet browsing data comprises browser window environment data that is captured by leveraging the browser extension to access each window object through a browser application programming interface.

18. The system of claim 14, wherein:
the Internet browsing data comprises a browser redirect that is detected using a browser application programming interface event that detects when navigation to a webpage starts and when a completed event occurs.

19. The system of claim 14, wherein:
the Internet browsing data comprises clickjacking information that is detected by leveraging a browser extension application programming interface event that indicates how a webpage was opened.

20. The system of claim 14, wherein:
the Internet browsing data comprises information regarding whether and how long a window/tab displaying a webpage becomes active.

21. The system of claim 14, wherein:
the Internet browsing data comprises online advertisement and media/content exposure, that is detected by the browser extension that captures all hypertext transfer protocol (HTTP) request activity generated by the Internet browser.

22. The system of claim 14, wherein:
a webpage visit is intentional when a uniform resource locator (URL) for the webpage is visible in a browser window/tab's address bar.

23. The system of claim 14, wherein:
a webpage visit is active and intentional when a loading of the webpage is initiated by a real user and viewed for a period of time of at least seven (7) seconds.

24. The system of claim 14, wherein utilizing the Internet browsing data comprises:
based on the Internet browsing data, rating and ranking websites in terms of user/audience reach and page views.

25. The system of claim 14, wherein utilizing the Internet browsing data comprises:
based on the Internet browsing data, rating and ranking online advertisement exposure.

26. The system of claim 14, wherein utilizing the Internet browsing data comprises:
based on the Internet browsing data, measuring a distribution of online media content.
